(19) United States
(12) Patent Application Publication
(10) Pub. No.: US 2022/0184980 A1
(43) Pub. Date: Jun. 16, 2022

(54) CUTTER ASSEMBLIES

(71) Applicant: Hewlett-Packard Development Company, L.P., Spring, TX (US)

(72) Inventors: Xavier Domingo Reguant, Sant Cugat del Valles (ES); Alberto Arredondo Rosales, Sant Cugat del Valles (ES); Ivan Lopez Avila, Sant Cugat del Valles (ES)

(73) Assignee: Hewlett-Packard Development Company, L.P., Spring, TX (US)

(21) Appl. No.: 17/417,704

(22) PCT Filed: Jul. 31, 2019
(86) PCT No.: PCT/US2019/044412

§ 371 Date: Jun. 23, 2021

(51) Int. Cl. B41J 11/70; B26D 1/06; B26D 5/06

(52) U.S. Cl. CPC B41J 11/706; B26D 5/06; B26D 1/065

(57) ABSTRACT

The present disclosure refers to a cutter assembly for a printer, the cutter assembly including: a cutter module including a cutting blade; a support element extending along a cutting direction; and a carriage module to move the cutter module along the support element; wherein the carriage module is moved by a motor, the motor being controlled by a controller to move at a substantially constant speed along the cutting direction, and wherein the controller monitors a power signal of the motor and detects a cutting feature in the cutting direction based on the power signal.

### BACKGROUND

Some printers include a cutter assembly which can cut a print medium before or after a printing operation. The cutter assembly may include a cutter module having a cutting blade supported on a carriage to move across a print zone. By movement of the carriage across the print zone and/or movement of the print medium along a media advance path through the print zone, the cutter module may cut in one or two linear directions, such as the X and Y directions.

### BRIEF DESCRIPTION OF DRAWINGS

The following description references the drawings, wherein FIG. 1 is a schematic perspective overview of a cutter assembly, according to an example;

FIG. 2 shows a schematic front view of a cutter assembly in a printer according to an example;

FIG. 3 a schematic top view of a printer according to an example;

FIG. 4 an example of a method to determine a cutting feature;

FIG. 5 an example of a reference signal obtained without media in a cutting direction.

FIG. 6 an example of a power signal while cutting a media.

FIG. 7 an example of a power signal while cutting a media when a media jam has occurred.

FIG. 8 an example of a power signal while cutting a media when a motor slippage has occurred

### DETAILED DESCRIPTION

In the present disclosure it is describer a cutter assembly including: a cutter module including a cutting blade; a guiding element extending along a cutting direction; and a carriage module to move the cutter module along the guiding element; wherein the carriage module is moved by a motor, the motor being controlled by a controller to move at a substantially constant speed along the cutting direction, and wherein the controller monitors a power signal of the motor and detects a cutting feature in the cutting direction based on the power signal.

In an example, the controller may detect the cutting feature upon comparison between the power signal and a reference signal. The reference signal may be, e.g., a threshold range and/or a predefined cutter calibration signal.

Also, the cutter assembly may comprise a speed sensor to determine the speed of the motor being the speed sensor to provide a speed signal to the controller. Examples of such sensors may be a quadrature encoder that may be associated to the shaft of the motor.

In an example, the controller is to detect the cutting feature in the cutting direction based on both the power signal and the speed signal.

The cutting feature may be an abnormality along the cutting path, for example, one selected from a bump, a media jam, and a motor slippage.

Also, the present disclosure refers to a method to detect cutting features along a cutting direction of a cutting assembly, the method being implemented in a controller, being the controller to: issue a power signal to a motor associated to the cutting assembly to move the cutting assembly at a substantially constant speed; monitor the power signal; and determine a presence of a cutting feature as a result of the monitoring of the power signal.

In an example, an increase in the power signal over a reference signal is determined as a cutting feature. Such increase may be, e.g., an increase above a threshold or a gradient increase in a determined period.

In a further example, the cutting feature comprises one selected from a bump, a media jam or a motor slippage.

Also, the controller may be to further monitor, by a speed sensor, the speed of the motor and wherein the controller is to determine based on the speed of the motor and the power signal the presence of the cutting feature.

Finally, the present disclosure also refers to a non-transitory computer-readable medium containing program instructions for causing a controller to perform any of the above-mentioned methods.

An implementation of the present cutter assembly may be incorporated in a printing system. In such a case the printing system, may include: a controller; a cutter module including a cutting blade; a guiding element extending along a cutting direction; and a carriage module to move, by a motor, the cutter module along the guiding element; wherein the controller monitors a power signal of the motor and to compare the power signal with a reference signal and identify a cutting feature based on the comparison.

In an example, the system may further comprise a speed sensor to determine the speed of the motor and wherein the controller is to receive a speed signal from the speed sensor and identify a cutting feature based on the speed signal and the comparison.

FIG. 1 provides an overview of a cutter assembly according to an example. In this example, the cutter assembly may be provided for example in a printer, such as a large format printer which prints on a continuous web of a print medium, such as a continuous web of paper, carton, foil, glossy and coated material, backlighting material, or textile, including thick and/or rigid printing media, such as canvas having a thickness of 0.2 to 0.4 mm, for example. The print medium also may be provided as single sheets that are fed from an input tray or a drawer, or a roll of any of the above materials, for example. The printer may be an inkjet printer or another type of printer, including but not limited to a scanning printer which comprises a printer carriage (not shown) which carries one or several print heads. The printer carriage may scan across a print zone, schematically shown by a number of print platens 10, in a scanning direction and the print head(s) may deposit a printing fluid on the print medium, when the print medium is transported through the print zone in a print media advance direction. For example, one replaceable ink jet print head or four, MCYK, ink inkjet print heads may be provided in the carriage. A printing fluid may be dispensed from the print heads which may be any fluid that can be dispensed by an inkjet-type printer or other inkjet-type dispenser and may include inks, varnishes, and/or post or pre-treatment agents, for example.

A print zone may be defined as the entire area or part of the area which can be traversed by the carriage. The scanning direction of the carriage also may be designated as X direction, the print media advance direction also may be designated as Y direction, and the direction of gravity also may be designated as Z direction. In the context of this application, a front view of the printer and of cutter assembly corresponds to a view in the X-Z plane, and a side view corresponds to a view in the Y-Z plane. A top view corresponds to a view in the X-Y plane. Directions, such as up and down, above and below, or right and left are defined as shown in the drawings.

FIG. 1 schematically shows a cutter assembly 1 including a support element 20, extending along a cutting direction which is aligned to the scanning direction X of the printer carriage (not shown). In a printer, the carriage can move along a slide bar, e.g., provided on the support element 20. A cutter module 30 can be engaged with the printer carriage to move along the support component 20 by it following movement of the carriage. The support component 20 may be located below or over the print zone, schematically illustrated by platen 10. The cutter module 30 may be located partially above and partially below the print zone, as described in further detail below. For example, the cutter module may include a rotary cutting blade and a gear associated with the rotary cutting blade, wherein rotation of the gear is transmitted to the rotary cutting blade to drive the rotary cutting blade. In other examples, the cutter module 30 may include a cutting blade which may be a knife-like blade.

As for the movement along the cutting direction, the assembly may further comprise a toothed belt 40 which extends along the support component 20 in the cutting direction X and which is arranged to engage with the gear. A distal end of the belt 40 may be recognized that the right-hand side of FIG. 1 wherein this end of the belt may be fixed to the support element, as explained further below. The support element 20 may also support and guide the toothed belt 40, in the following also simply referred to as the belt. To perform a cutting movement, a motor may be provided to move the cutter module 30, for example, by rotating the gear in case of a toothed belt-gear arrangement as provided in the example of FIG. 1, nonetheless, this arrangement should be understood as an illustrative example and other types of arrangement to move the carriage may be implemented within the scope of the current disclosure.

In operation, a print medium may be transported through the print zone above platen 10 where a print fluid is to be deposited on the print medium. The printer may further comprise a print medium advance system to transport the print medium through the print zone in the media advance direction Y. The print media advance system may comprise media transport rollers, for example. Further, if the print medium is to be cut in a direction orthogonal to the print media advance direction, the cutter module 30 can be engaged with the carriage and the carriage can be moved in the scanning direction X, with the cutter module following movement of the carriage along the support component. During movement of the cutter module 30 along the support component 20, the gear may engage with the belt 40 to rotate the gear wherein rotation of the gear is transmitted to the rotary cutting blade to rotate the blade to cut the print medium. During movement of the cutter module 30, the support component 20 supports and guides both the cutter module 30 and the belt 40. Further, during movement of the cutter module 30, the cutter assembly may bias the gear against the belt 40 to ensure rotation of the rotary cutting blade and avoid slippage even if cutting thick print media, such as canvas.

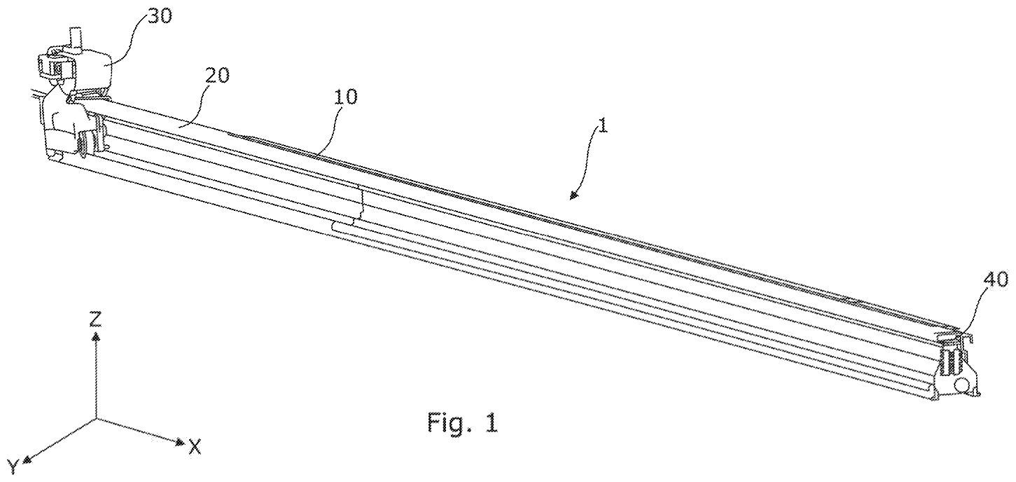

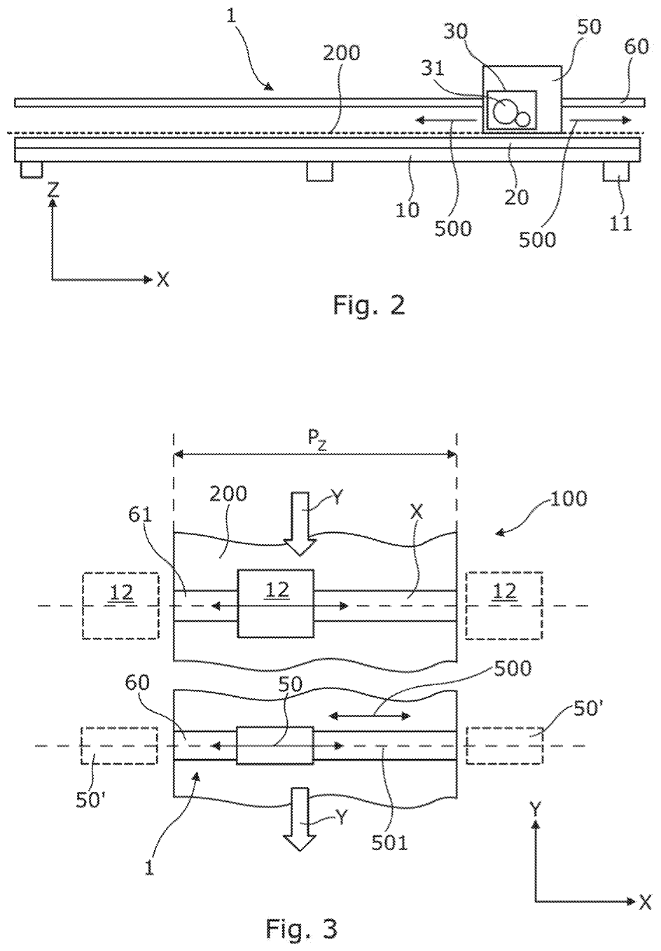

Further details of an example of a cutter assembly including a cutter module 30 are described with reference to FIGS. 2 and 3. These and the other drawings may relate to the same example or to different examples, i.e. features shown in the drawings may be combined in any useful way and the illustrated features can be but do not have to be present in combination. Other combinations of features than shown can be implemented. Except as defined in the independent claims, features may be exchanged, replaced or omitted.

FIG. 2 schematically shows a front view of a printer according to an example, including the cutter assembly 1 comprising a carriage module 50 which carries a cutter module 30. In this example, the cutter module 30 includes a cutter, e.g., a rotary cutting blade 31. The cutter module 30 can be designed to be lowered and raised and to engage and disengage the rotary cutting blade 31 with the print medium 20. The carriage module 50 is movable in the scanning direction X along a guiding element, such as a shaft 60. The printhead assembly, including the printhead carriage, may be located behind the cutter assembly 1 and is not visible in FIG. 2. Below the cutter assembly 1, the print medium is schematically shown at 200. The print medium 200 is transported below the cutter assembly 1 and over the support element 20 in the medium advance direction Y which, in FIG. 2, is perpendicular to the drawing plane.

In the example of FIG. 2, the rotary cutting blade 31 may interacts with an opposite linear cutting blade which may be attached to a support element 20 which may be raised and lowered via actuators 11 to engage and disengage the rotary cutting blade 31 and the opposite linear cutting blade to cut the print medium therebetween.

The carriage module 50 is connected to a motor so that a power signal sent to the motor moves the carriage module 50 bidirectionally along the cutting direction 500. In an example, the power signal may be a direct current (DC) signal, an alternate current (AC) signal or, in an example, a pulsed signal controlled by pulse-width modulation (PWM). In an example, a controller is to determine the power signal that is sent to the carriage module 50.

FIG. 3 shows a schematic top view of a printing system 10, including print medium 200 which advances below the printhead assembly 12 in the medium advance direction Y. The printhead assembly 12 comprises a carriage to move over the print medium 20 in opposite scanning directions X perpendicular to the print medium advance direction Y and parallel to the cutting direction C. The printhead assembly 12 scans across the print zone, printing a swath S on the print medium 200 after each medium advance movement.

In an alternative configuration, not shown in the drawings, the printer includes a page wide print bar which extends across the width of the print medium 20, perpendicular to the medium advance direction Y. Also, in this case, the print bar can print swathes on the print medium 20 after each medium advance movement. The cutter module is carried by an associated carriage module 50 and scans and cuts along a cut line 501, for example, downstream of the print zone.

A controller instructs the printhead assembly 12 to print respective image slices between two medium advance movements for printing on subsequent portions of the print medium 200, instructs the cutter assembly 1 to cut between two defined medium advance movements, for separating a printed image from the print medium during the scanning action and without interrupting the print process of the print medium 20 currently undergoing printing.

In an example, a controller is to instruct the controller to move along the cutting direction 501 when a cutting operation is needed. In an example, the carriage module 50 is moved by a motor along a guiding element 60. The motor may be coupled to the carriage, e.g., by a gear-belt assembly and may be to move the carriage module 50 bidirectionally along the guiding element. Further, the carriage module 50 may move between parking zones 50′ wherein deceleration and acceleration of the carriage module 50 is performed and a print zone Pz wherein the carriage module 50 may be moved by the motor at a substantially constant speed. In an example, the parking zones 50′ are adjacent to the print zone. The movement of the carriage at a constant speed on the print zone helps achieve a uniform cut throughout the media.

A controller may be provided to monitor the power signal applied to the motor to maintain the motor moving at a substantially constant speed along the print zone Pz. Therefore, the controller may monitor such power signal to identify possible cutting features that may be present along a cutting operation, such cutting features may be, e.g., a bump defining a limit of movement of the carriage module 50, a media jam, a belt slippage, lack of lubrication, defects on the guiding element, or the like. For example, an increase on the power signal to maintain the carriage module 50 at a constant speed may indicate that further energy is needed to move the carriage module 50 which may be indicative of cutting features.

In a further example, the motor may be provided with a sensor associated to the speed transmitted to the carriage module 50, for example, the motor may comprise a quadrature encoder sensor associated to its shaft, such sensor is indicative of the speed of the shaft that is later transmitted to the carriage module 50. The speed sensor may be feedback to the controller so that the controller is provided with information regarding the power applied to the motor as to move the carriage module 50 at a reference speed and the actual speed provided by the motor.

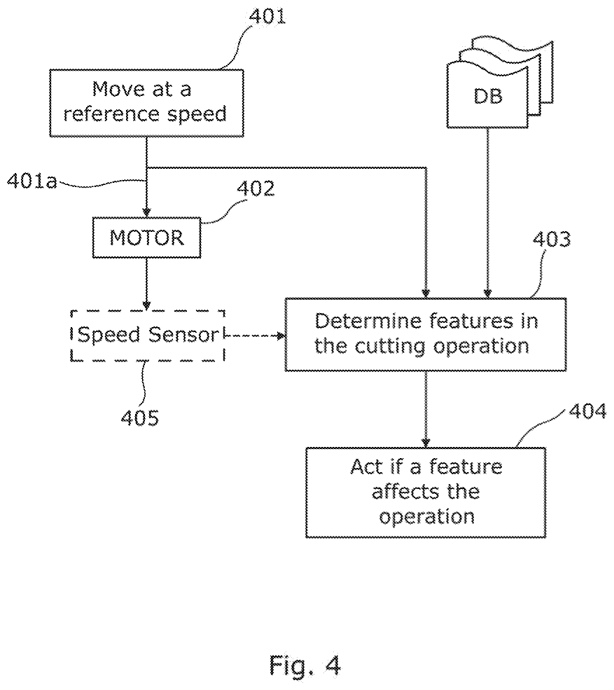

FIG. 4 shows an example of a method to determine a cutting feature in the cutting path of an assembly according to the present disclosure. In the example of FIG. 4, the controller may instruct the motor 402 so that the carriage module moves at a reference speed 401, for example, the reference speed may be a constant speed as the carriage module passes along part of the print zone, i.e., where a cutting operation is to be performed. This may be achieved by setting a power signal 401a that is applied to the motor 402, e.g., in case the motor is fed by PWM, setting the duty cycle, and frequency of the power signal as to move the motor at the reference speed.

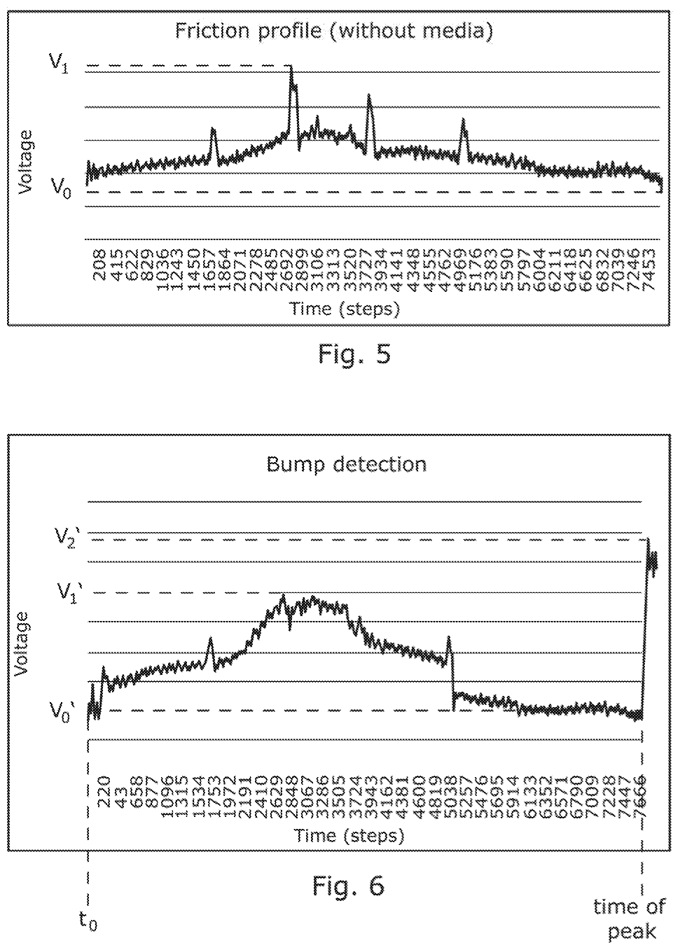

Then, a controller may receive the power signal 401a and monitor such signal determine features in the cutting operation 403. Following the example in which the power signal is a PWM signal, the controller may monitor the root mean square (RMS) value, an average value or the like of the power signal and determine possible abnormalities in such a signal. As will be described later with reference to FIGS. 5-8, the abnormalities in the power signal may be correlated to cutting features such as, e.g., limit bumps, media jams, and/or motor slippage.

In an example, the controller may be provided with access to a reference database 406 wherein, for example, a reference signal is provided so that the controller may compare the power signal 401a with a reference signal and, in view of such a comparison determine if a feature is present or if the signal does not have any abnormalities. In an example, the reference signal may be a power signal obtained in a calibration pass of the carriage module, i.e., without media in the cutting path.

Finally, the controller may act if the previously determined feature may affect the cutting and/or the printing operation 404. For example, the controller may instruct the cutting assembly 1 or the printing system 100 to stop their operations, nonetheless, in a further example, even if an abnormality is detected, the controller may decide that it is not severe enough to stop a cutting and/or printing operation

FIG. 5 shows an example of a reference signal acquired while the carriage module moves through the print zone at a reference speed. As can be seen from FIG. 5 the reference signal moves in values between V₀ and V₁ with some peaks that may be related to possible rugosities in the guiding surface or the like.

In view of FIG. 5, the controller may use as the reference signal for comparison with the power signal and establish threshold values wherein, if the signal exceeds or is below the threshold value, it is considered that there is an abnormality, e.g., a threshold may be defined as a range between ΔV₀ and ΔV₁ being Δ>1, and wherein Δ is a factor associated to a tolerance or to the media to be cut. In a further embodiment the reference signal does not relate only to the limit values V₀ and V₁ but is a signal defining values for a plurality of positions along the cutting direction, i.e., each of the positions from the plurality of positions has an associated threshold value.

FIG. 6 is an example of a power signal as received by the controller for monitoring a cutter assembly while cutting a media. In the example o FIG. 6 in instant t₀ the carriage module enters the print zone as to move at a reference speed, the power signal is maintained during the print zone between threshold values V₀′ and V₁′ as it cuts the media. In an example, V₀′ and V₁′ may be obtained by doing a calibration run with no media and then determining a tolerance factor to the values obtained during the calibration run.

At instant t₁a steep increase of the power signal is determined. Such steep increase is caused due to a further effort was required from the motor to maintain the reference speed. In the example of FIG. 6, the magnitude of the increase is such that it may be the result of a feature on the cutting direction. Such feature generates an abnormality in the power signal because the carriage stopped suddenly, in this case, the carriage reached the limit bump on instant t₁. i.e., the feature in the cutting direction is the presence of a limit bump. In this case, the magnitude of the power signal exceeds a threshold value V₁′ until it reaches V₂′ which may trigger the controller to determine the presence of an abnormality.

In an example, the controller may monitor the power signal and determine a differential increase between an instant before t₁ and t₁ and determine that, if such difference exceeds a threshold, the presence of a feature is identified, such as a bump or an artifact that causes a stop on the carriage and, as a result, the controller may take actions, e.g., communicate with the motor to perform an emergency stop.

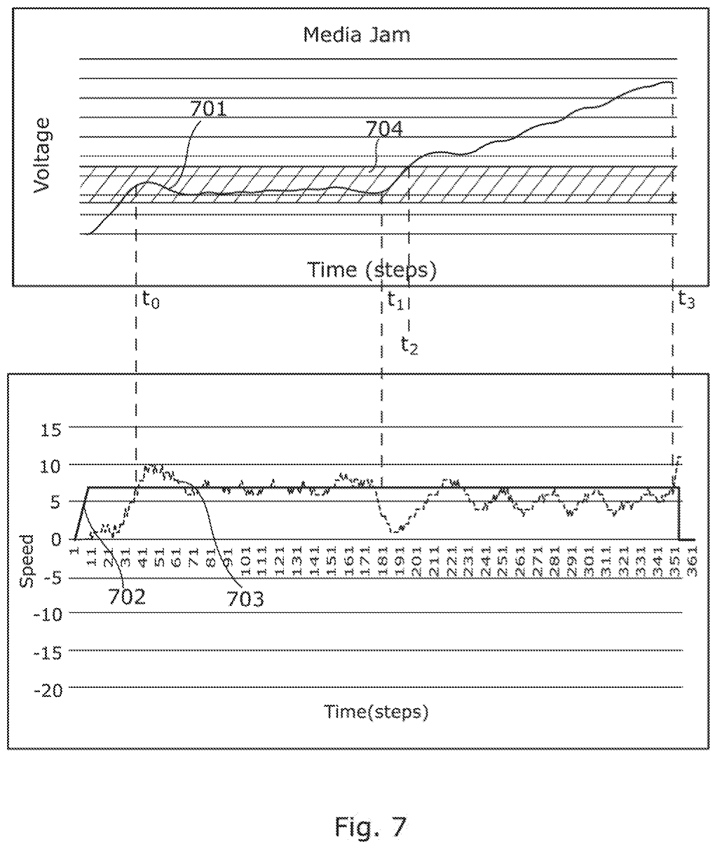

FIG. 7 shows a further example of a carriage assembly wherein the carriage is provided with a controller to monitor a power signal 701 that is sent to the motor to cause the carriage to move at a determined speed. In this case, the controller is also provided with a speed signal 703 provided from a speed sensor associated to the motor, e.g., a quadrature encoder associated to the shaft of the motor.

In an example, the controller would be to determine features in a cutting operation based on the power signal 701 and, optionally, based on the speed signal 703.

In the example of FIG. 7, the motor is instructed to move the carriage at a reference speed 702. As can be seen, the speed increments until in time to reaches the print zone and is to move substantially at the reference speed so the motor is instructed to maintain such reference speed. As a result, the power signal 701 of the motor is maintained substantially within a predefined threshold 704 associated to a reference signal obtained in a calibration procedure.

At instant t₁ the power signal starts increasing at a moderate rate until, in instant t₂ exceeds the threshold 704. The controller may, on one hand, compare the increase rate at different instants, if the rate of increase is too high it may trigger an emergency stop of the motor. If the increase rate is moderate but the power signal 701 exceed the threshold 704 the controller may identify the feature as a possible media jam and decide whether to continue moving the carriage module or stop.

Additionally, if the controller is provided with the speed signal 703, it may determine whether the increase of the power signal 701 causes the motor to move or if the motor is stopped, i.e., if the feature is severe enough to cause damages on the motor. The speed signal 703 may help the controller differentiate a media jam, in which the motor has enough torque to continue the cutting path, or if the feature is so severe that is better to stop the motor, e.g., a severe jam, a bump or an obstacle in the cutting path.

The cutter assembly may include comprises a belt extending in the cutting direction X and being arranged so that the teeth of the belt are facing a gear associated to the motor as to couple thereto. The belt may be made of or include material having some elasticity, such as including either of or a combination of some of silicon rubber, polyurethane, nylon and Aramide fibers. The belt may have a stretch or extension ratio of about 102% to 110% at room temperature.

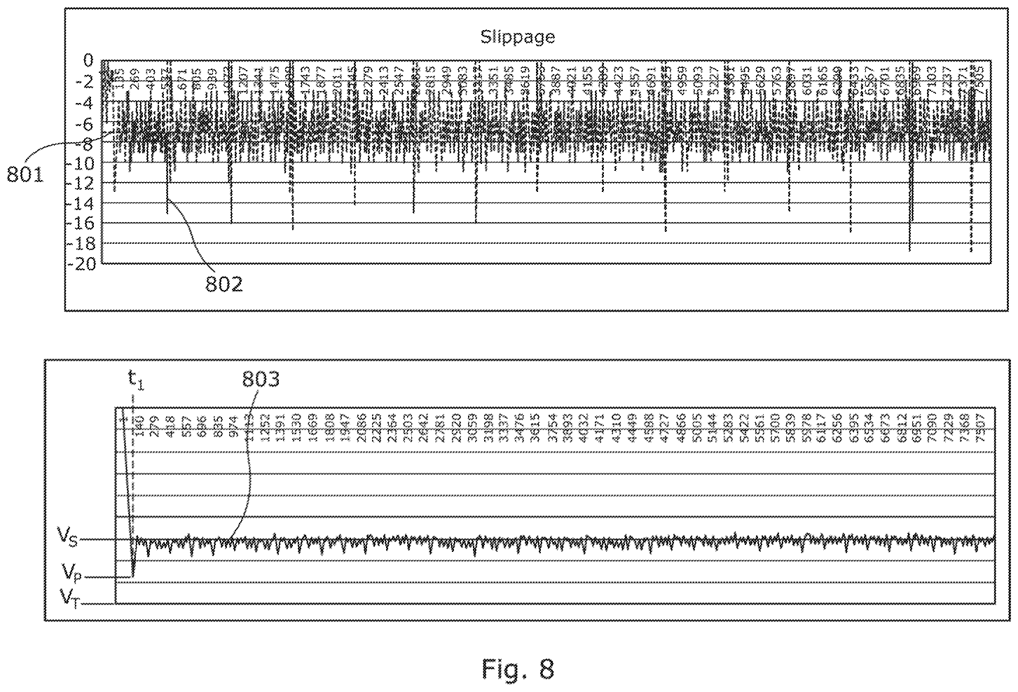

FIG. 8 shows a graph wherein a belt slippage may be detected for a cutter assembly. In particular, FIG. 8 shows a case in which two signals are analyzed: a power signal 802 associated to the input provided to the motor; and a speed signal 803 associated to an encoder associated, e.g., to a shaft of the motor that is to move the carriage along the cutting direction.

In the example of FIG. 8, in time t₁ the cutter reaches an end-of-track bump. In normal conditions, as explained with reference to FIG. 6 above, the power signal would have reached a threshold value V_{T} and the controller would have been able to identify such abnormality. In contrast, in this case, the power signal 802 reaches, at t₁ a peak value V_{P} and then stabilizes at a determined power V_{S}.

As for the speed, in this case a non-stable signal is measured with amean value 801 around −7. This kind of behavior is representative of reaching a bump but still being able to move the shaft of the motor while not moving the carrage, i.e., a slippage between the motor shaft and the carriage, in this case, the belt that connects them.

The controller may be provided to determine a possible slippage abnormality by, e.g., having predetermined period of movement of the carriage, if the motor is still able to move (if some speed is detected in a sensor associated to the motor and/or if the motor has not reached the power threshold), then the controller may determine that an abnormality due to slippage may be occurring.

In a further example, a user may position or determine that the carriage is in the bump position and instruct the controller to move the carriage towards the bump position. If there is no abnormality, the power signal should reach the threshold power and/or the speed sensor should detect that the motor is static, if at least one of these conditions is not met, an abnormality due to slippage may be occurring and the controller may, e.g., issue an alert signal to the user.

Drive of the carriage (i.e., the issuance of the power signal to the motor), the print system and any actuator(s), e.g. for coupling the cutter module and the carriage, may be controlled by a controller (not shown). The controller can be a microcontroller, ASIC, or other control device, including control devices operating based on software or firmware, including machine readable instructions, hardware, or a combination thereof. It can include an integrated memory or communicate with an external memory or both. The same controller or separate controllers may be provided for controlling carriage movement, print engine and any actuators. Different parts of the controller may be located internally or externally to a printer or a separate cutting device, in a concentrated or distributed environment.

1. A cutter assembly for a printer, the cutter assembly including:
a cutter module including a cutting blade;
a guiding element extending along a cutting direction; and
a carriage module to move the cutter module along the guiding element;
wherein the carriage module is moved by a motor, the motor being controlled by a controller to move at a substantially constant speed along the cutting direction, and
wherein the controller monitors a power signal of the motor and detects a cutting feature in the cutting direction based on the power signal.

2. The cutter assembly of claim 1, wherein the controller detects the cutting feature upon comparison between the power signal and a reference signal.

3. The cutter assembly of claim 2, wherein the reference signal is a threshold range.

4. The cutter assembly of claim 2, wherein the reference signal is a predefined cutter calibration signal.

5. The cutter assembly of claim 1, further comprising a speed sensor to determine the speed of the motor being the speed sensor to provide a speed signal to the controller.

6. The cutter assembly of claim 5, wherein sensor is a quadrature encoder.

7. The cutter assembly of claim 5, wherein the controller is to detect the cutting feature in the cutting direction based on the power signal and the speed signal.

8. The cutter assembly of claim 1 wherein the cutting feature comprises one selected from a bump, a media jam, and a motor slippage.

9. A method to detect cutting features along a cutting direction of a cutting assembly, the method being implemented in a controller, being the controller to:
issue a power signal to a motor associated to the cutting assembly to move the cutting assembly at a substantially constant speed;
monitor the power signal;
determine a presence of a cutting feature as a result of the monitoring of the power signal.

10. The method of claim 9 wherein an increase in the power signal over a reference signal is determined as a cutting feature.

11. The method of claim 9 wherein the cutting feature comprises one selected from a bump, a media jam or a motor slippage.

12. The method of claim 9 wherein the controller is further to monitor, by a speed sensor, the speed of the motor and wherein the controller is to determine based on the speed of the motor and the power signal the presence of the cutting feature.

13. A non-transitory computer-readable medium containing program instructions for causing a controller to perform a method according to claim 9.

14. A printing system, including:
a controller;
a cutter module including a cutting blade;
a guiding element extending along a cutting direction; and
a carriage module to move, by a motor, the cutter module along the guiding element;
wherein the controller monitors a power signal of the motor and to compare the power signal with a reference signal and identify a cutting feature based on the comparison.

15. The printing system of claim 14, further comprising a speed sensor to determine the speed of the motor and wherein the controller is to receive a speed signal from the speed sensor and identify a cutting feature based on the speed signal and the comparison.
